(19) United States
(12) Patent Application Publication
(10) Pub. No.: US 2023/0017299 A1
(43) Pub. Date: Jan. 19, 2023

(54) Wheel Removal Device

(71) Applicant: Samuel Chichino, Steubenville, OH (US)

(72) Inventor: Samuel Chichino, Steubenville, OH (US)

(21) Appl. No.: 17/374,598

(22) Filed: Jul. 13, 2021

(51) Int. Cl. B60B 29/00; B66F 3/26

(52) U.S. Cl. CPC B60B 29/008; B66F 3/26

(57) ABSTRACT

A wheel removal device for separating a wheel from an axle hub includes a base, a plurality of tethers, and a plurality of fasteners. A recess extends axially into the base from a first end of the base. The recess is shaped complementarily to a terminus of a piston of a hydraulic cylinder so that the recess the terminus of the piston can be inserted into the recess. The tethers are engaged to and extend from the base. Each fastener is engaged to a respective tether distal from the base and can selectively engage a wheel that is engaged to an axle hub. The hydraulic cylinder is positioned longitudinally between the base and the axle hub. The base translates a force imparted by extension of the piston through the tethers to the wheel to remove the wheel from the axle hub.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to removal devices and more particularly pertains to a new removal device for separating a wheel from an axle hub. The present invention discloses a removal device comprising a plurality of tethers extending from a base. Fasteners engaged to the tethers are configured to engage apertures in a wheel. A hydraulic cylinder then can be used to separate the wheel from an axle hub to which the wheel is attached.

### (2) Description of Related Art Including Information Disclosed Under 37 CFR 1.97 and 1.98

The prior art relates to removal devices. The prior art discloses various devices used with jacks to lift a wheel assembly or a vehicle, and one manually operated removal device which does not work with a hydraulic cylinder. What is lacking in the prior art is a removal device which can be used with a hydraulic cylinder to separate the wheel from an axle hub to which the wheel is attached.

### BRIEF SUMMARY OF THE INVENTION

An embodiment of the disclosure meets the needs presented above by generally comprising a base, a plurality of tethers, and a plurality of fasteners. A recess extends axially into the base from a first end of the base. The recess is shaped complementarily to a terminus of a piston of a hydraulic cylinder so that the recess is configured for insertion of the terminus of the piston. The tethers are engaged to and extend from the base. Each fastener is engaged to a respective tether distal from the base and is configured to selectively engage a wheel that is engaged to an axle hub. The hydraulic cylinder is positioned longitudinally between the base and the axle hub. The base is configured to translate a force imparted by extension of the piston through the tethers to the wheel to remove the wheel from the axle hub.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric perspective view of a wheel removal device according to an embodiment of the disclosure.

FIG. 2 is a side view of an embodiment of the disclosure.

FIG. 3 is a bottom view of an embodiment of the disclosure.

FIG. 4 is an in-use view of an embodiment of the disclosure.

FIG. 5 is an in-use view of an embodiment of the disclosure.

FIG. 6 is an in-use view of an embodiment of the disclosure.

### DETAILED DESCRIPTION OF THE INVENTION

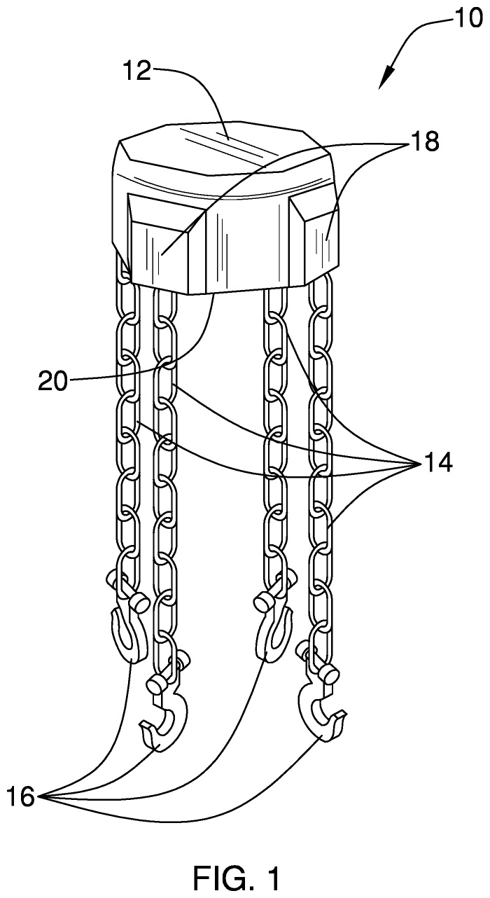

With reference now to the drawings, and in particular to FIGS. 1 through 6 thereof, a new removal device embodying the principles and concepts of an embodiment of the disclosure and generally designated by the reference numeral 10 will be described.

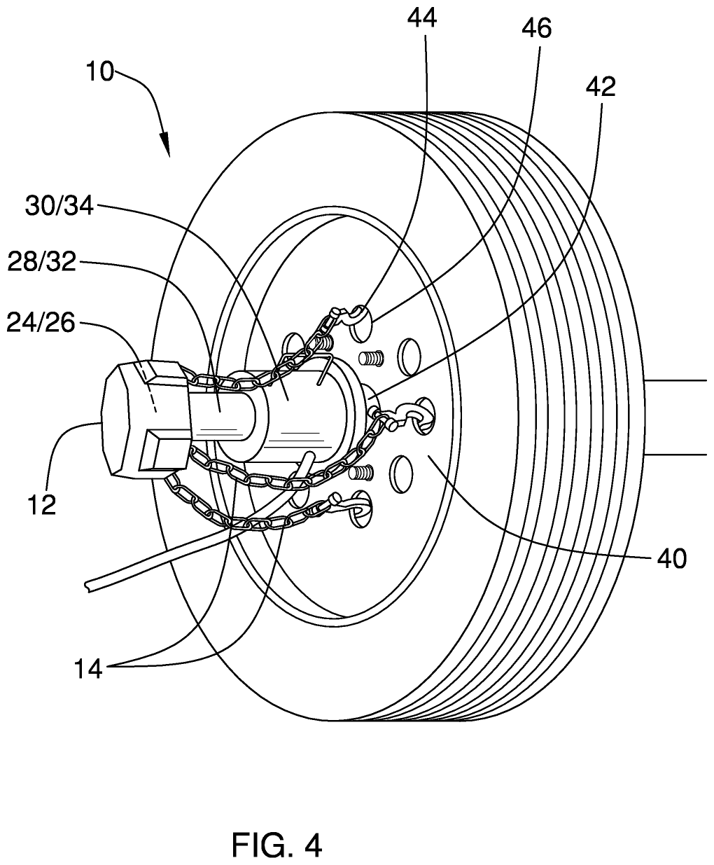

As best illustrated in FIGS. 1 through 6, the wheel removal device 10 generally comprises a base 12, a plurality of tethers 14, and a plurality of fasteners 16. The base 12 may be substantially cylindrically shaped, as shown in FIG. 3, although the present invention also anticipates the base 12 being cuboid shaped, having a pentagonal cross-sectional profile, and the like. A plurality of protrusions 18 is engaged to the base 12. The protrusions 18 are positioned adjacent to a first end 20 of the base 12 and are substantially evenly spaced around a circumference 22 of the base 12.

A recess 24 extends axially into the base 12 from the first end 20 of the base 12. The recess 24 is shaped complementarily to a terminus 26 of a piston 28 of a hydraulic cylinder 30 so that the recess 24 is configured for insertion of the terminus 26 of the piston 28. The recess 24 may be shaped complementarily to a ram 32 of a bottle jack 34.

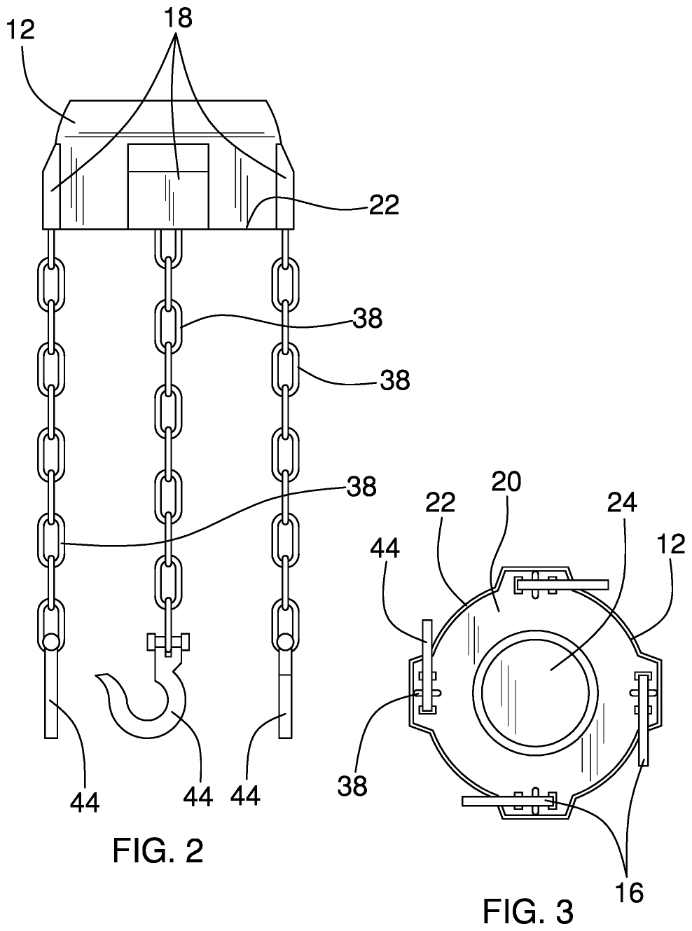

The tethers 14 are engaged to and extend from the base 12. The plurality of tethers 14 is engaged to the first end 20 of the base 12, as shown in FIG. 2, although the present invention also anticipates the tethers 14 being engaged to a sidewall 36 of the base 12. As shown in FIG. 3, each tether 14 may be engaged to a respective protrusion 18. The plurality of tethers 14 comprises at least four tethers 14. Each tether 14 may comprise a chain 38, as shown in FIG. 2, or other tethering means, such as, but not limited to, cables, ropes, and the like.

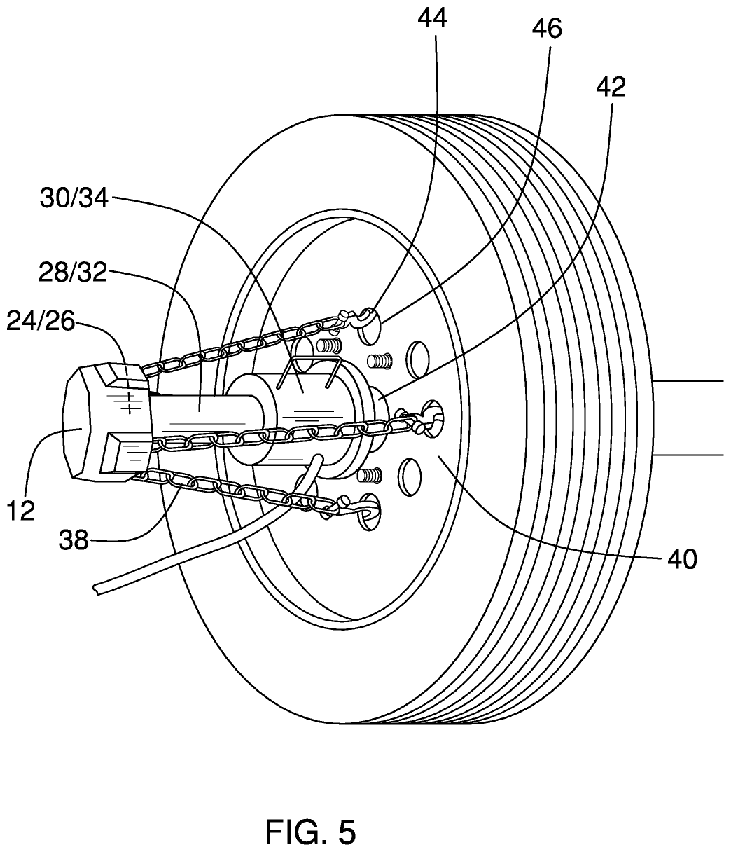

Each fastener 16 is engaged to a respective tether 14 distal from the base 12. The fastener 16 is configured to selectively engage a wheel 40 that is engaged to an axle hub 42, as shown in FIG. 4, such that the hydraulic cylinder 30 is positioned longitudinally between the base 12 and the axle hub 42. The base 12 is configured to translate a force imparted by extension of the piston 28 through the tethers 14 to the wheel 40 to remove the wheel 40 from the axle hub 42. As shown in FIG. 4, each fastener 16 comprises a hook 44, which is configured for insertion of into a respective aperture 46 in the wheel 40 so that the hook 44 is engaged to the wheel 40. The present invention anticipates the fastener 16 comprising other fastening means, such as, but not limited to, rods, bars, and the like, which could be inserted longitudinally through the apertures 46 and then rotated to engage the wheel 40.

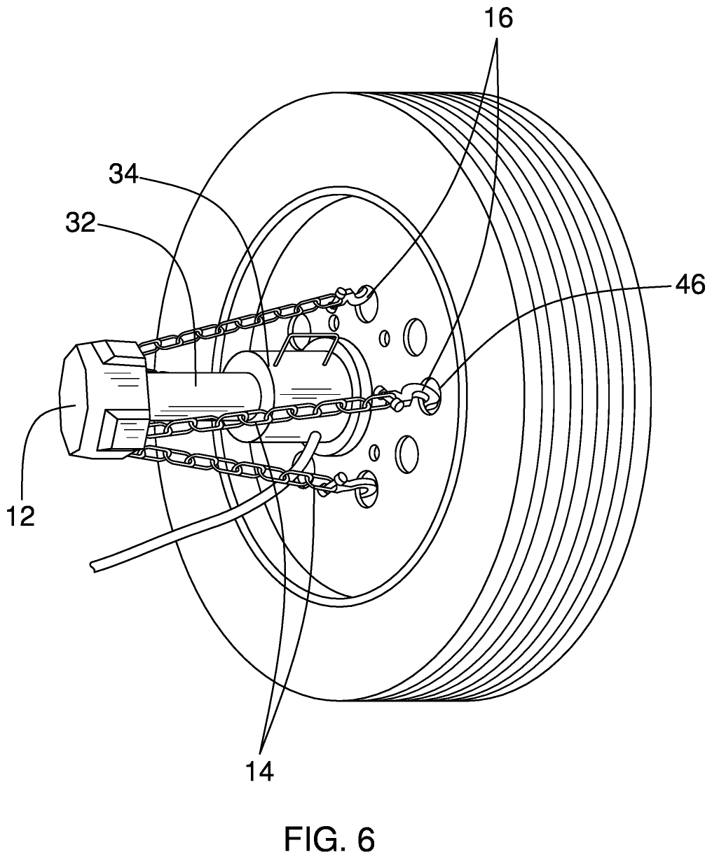

In use, the hooks 44 are engaged to the wheel 40 by inserting them through the apertures 46. The bottle jack 34 then is positioned between the base 12 and the axle hub 42 with the ram 32 extending into the recess 24, as shown in FIG. 4. The bottle jack 34 is first engaged to tighten up the chains 38, as shown in FIG. 5. The ram 32 then is further extended to apply force to the wheel 40 to separate it from the axle hub 42, as shown in FIG. 6. The present invention is anticipated to be useful in removing a wheel 40 that is stuck to an axle hub 42, such as a wheel 40 on an axle hub 42 of a truck.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A wheel removal device comprising:
a base;
a recess extending axially into the base from a first end of the base, the recess being shaped complementarily to a terminus of a piston of a hydraulic cylinder, wherein the recess is configured for insertion of the terminus of the piston;
a plurality of tethers engaged to and extending from the base; and
a plurality of fasteners, each fastener being engaged to a respective tether distal from the base and being configured for selectively engaging a wheel engaged to an axle hub, such that the hydraulic cylinder is positioned longitudinally between the base and the axle hub, wherein the base is configured for translating a force imparted by extension of the piston through the tethers to the wheel for removing the wheel from the axle hub.

2. The wheel removal device of claim 1, wherein the recess is shaped complementarily to a ram of a bottle jack.

3. The wheel removal device of claim 1, wherein the plurality of tethers is engaged to the first end of the base.

4. The wheel removal device of claim 1, wherein the plurality of tethers comprises at least four tethers.

5. The wheel removal device of claim 1, wherein each tether comprises a chain.

6. The wheel removal device of claim 1, further including a plurality of protrusions engaged to the base, the protrusions being positioned adjacent to the first end of the base and being substantially evenly spaced around a circumference of the base, each tether being engaged to a respective protrusion.

7. The wheel removal device of claim 1, wherein each fastener comprises a hook configured for inserting into a respective aperture in the wheel, such that the hook is engaged to the wheel.

8. The wheel removal device of claim 1, wherein the base is substantially cylindrically shaped.

9. A wheel removal system comprising:
a wheel engaged to an axle hub;
a hydraulic cylinder comprising a piston;
a base;
a recess extending axially into the base from a first end of the base, the recess being shaped complementarily to a terminus of the piston, such that the terminus of the piston is insertable into the recess;
a plurality of tethers engaged to and extending from the base; and
a plurality of fasteners, each fastener being engaged to a respective tether distal from the base and being positioned for selectively engaging the wheel, such that the hydraulic cylinder is positioned longitudinally between the base and the axle hub, such that extension of the piston applies a force to the base, the force being transferred through the tethers to the wheel for removing the wheel from the axle hub.

10. The wheel removal system of claim 9, wherein the hydraulic cylinder comprises a bottle jack and the piston comprises a ram.

11. The wheel removal system of claim 9, wherein the plurality of tethers is engaged to the first end of the base.

12. The wheel removal system of claim 9, wherein the plurality of tethers comprises at least four tethers.

13. The wheel removal system of claim 9, wherein each tether comprises a chain.

14. The wheel removal system of claim 9, further including a plurality of protrusions engaged to the base, the protrusions being positioned adjacent to the first end of the base and being substantially evenly spaced around a circumference of the base, each tether being engaged to a respective protrusion.

15. The wheel removal system of claim 9, wherein each fastener comprises a hook configured for inserting into a respective aperture in the wheel, such that the hook is engaged to the wheel.

16. The wheel removal system of claim 9, wherein the base is substantially cylindrically shaped.

17. A wheel removal device comprising:
a base, the base being substantially cylindrically shaped;
a recess extending axially into the base from a first end of the base, the recess being shaped complementarily to a terminus of a piston of a hydraulic cylinder, wherein the recess is configured for insertion of the terminus of the piston, the recess being shaped complementarily to a ram of a bottle jack;
a plurality of tethers engaged to and extending from the base, the plurality of tethers being engaged to the first end of the base, the plurality of tethers comprising at least four tethers, each tether comprising a chain;
a plurality of protrusions engaged to the base, the protrusions being positioned adjacent to the first end of the base and being substantially evenly spaced around a circumference of the base, each tether being engaged to a respective protrusion; and
a plurality of fasteners, each fastener being engaged to a respective tether distal from the base and being configured for selectively engaging a wheel engaged to an axle hub, such that the hydraulic cylinder is positioned longitudinally between the base and the axle hub, wherein the base is configured for translating a force imparted by extension of the piston through the tethers to the wheel for removing the wheel from the axle hub, each fastener comprising a hook configured for inserting into a respective aperture in the wheel, such that the hook is engaged to the wheel.
